(19) United States
(12) Patent Application Publication
(10) Pub. No.: US 2026/0217534 A1
(43) Pub. Date: Jul. 30, 2026

(54) PROCESS FOR THE RECOVERY OF A USEFUL MATERIAL FROM A BATTERY

(71) Applicant: MATERIALS PROCESSING INSTITUTE, Middlesbrough TS6 6US (GB)

(72) Inventors: Christopher Alan SMITH, Middlesbrough (GB); Tutu SEBASTIAN, Middlesbrough (GB); Simon John BLANCHARD, Middlesbrough (GB)

(21) Appl. No.: 19/147,650

(22) PCT Filed: Jan. 30, 2024
(86) PCT No.: PCT/EP2024/052152

§ 371 Date: Jul. 11, 2025

(30) Foreign Application Priority Data
Jan. 30, 2023 (GB) 2301309.7

(51) Int. Cl. C01B 25/30; B03C 1/30; C01B 25/32; C01B 32/20; C01D 1/04; C22B 1/248; C22B 7/00; H01M 10/54

(52) U.S. Cl. CPC C01B 25/30; B03C 1/30; C01B 25/32; C01B 32/20; C01D 1/04; C22B 1/248; C22B 7/007; H01M 10/54; B03C 2201/20

(57) ABSTRACT

A process for the recovery of a useful material from a battery, comprising the steps of: comminuting, discharging and shredding a battery to form a feed stream comprising anode material, cathode material and an electrolyte; removing the electrolyte from the feed stream; separating the anode material and cathode material from the feed stream into distinct material streams using (electro)magnetic separation; and treating the anode material stream to obtain a graphite product and/or treating the cathode material stream to obtain a cathode active material product.

### PROCESS

This application is a National Stage application which claims priority from the international application PCT/EP2024/052152, filed Jan. 30, 2024, which claims priority from GB application No. 2301309.7, filed Jan. 30, 2023. The entirety of aforementioned applications is incorporated herein by reference.

### FIELD

The present invention concerns a process for the recovery of a useful material from a battery, for example a lithium-ion battery.

### BACKGROUND

Lithium-ion batteries are increasingly used to power a vast range of products such as portable electronic devices, for example smart phones, small and large appliances, electric vehicles, and electrical energy storage systems. Whilst lithium-ion batteries can usually be recharged multiple times, they eventually no longer operate at sufficient capacity and reach the end of their useful life. These end-of-life (EOL) lithium-ion batteries generate a considerable amount of waste, are classed as hazardous waste and can have a damaging impact on the environment if not properly handled. Lithium-ion battery scrap is also generated in large amounts by gigafactories and can be classed as hazardous waste. Many critical materials are present in EOL lithium-ion batteries and in the scrap from gigafactories, for example graphite from the anode and cathode active materials such as lithium, cobalt, nickel and manganese. Therefore, it is important to have a mechanism to recover these materials and recycle them back into the supply chain.

Conventional battery recycling uses pyrometallurgical processes. In general, pyrometallurgical processes such as roasting or pyrolysis utilize an elevated temperature to extract metals or other compounds from diverse spent batteries. However, pyrometallurgical-based recycling is energy intensive and has a negative impact on the environment—due to substantial CO2 emissions and the generation of waste materials.

CN112635867 discloses a process for recovering a waste lithium battery graphite material using a multi-step process including scrubbing, magnetic separation, gravity separation, pyrolysis and flotation. By pyrolyzing the graphite anode material, the hydrophobicity of the surfaces of the graphite particles is recovered while organic impurities on the surface of the graphite are removed, and favourable conditions are created for flotation, purification and impurity removal of the graphite.

Alternative techniques such as those disclosed in CN113083848 and CN116024439 for the recycling of waste lithium batteries' electrode materials involve the use of chemical processes, such as oxidation, reduction or calcination to alter the magnetic properties of the active materials, so that the separation using an (electro)magnetic separation step is improved. However, these processes comprise harsh process steps, and magnetic separation is effected only after wet processing of the combined electrochemical cell materials, failing to recognise any benefit of separating anodic and cathodic materials in dry form prior to wet processing. Furthermore, not all constituent materials are recovered from the batteries using pyrometallurgy, in particular graphite and lithium tend to be lost in the process.

Hydrometallurgy has been proposed as an alternative process for the recycling of batteries, particularly lithium-ion batteries.

WO2018/218358 describes a process to recover materials from rechargeable lithium-ion batteries. The process involves processing the batteries into a size-reduced feed stream; and then, via a series of separation, isolation, and/or leaching steps, allows for recovery of a copper product, cobalt, nickel and/or manganese product, and a lithium product; and optional recovery of a ferrous product, aluminium product and graphite product.

WO2019/149698 describes a process for recycling lithium batteries, comprising the steps of: (a) digesting comminuted material which contains comminuted components of electrodes of lithium batteries, using concentrated sulfuric acid at a digestion temperature of at least 100° C., so that waste gas and a decomposition material are produced; (b) discharging the waste gas; and (c) performing wet-chemical extraction of at least one metallic component of the decomposition material.

WO2022/224264 describes a method to recover one or more battery materials from spent lithium-ion batteries. The method enables metals and non-metals to be extracted from cathode and anode electrode materials of lithium batteries in dry and wet powder form using multiple steps, including physical electro-mechanical separation, hydrometallurgical and chemical processes.

However, one of the main problems associated with the hydrometallurgy processes outlined in the above documents is the use of strong acids to leach out the constituent battery materials. Most frequently, inorganic acids, in particular sulfuric acid, hydrochloric acid and nitric acid, alkalis and organic acids are used as the leaching medium. Whilst these inorganic acids are effective in hydrometallurgy processes, their use results in the formation of hazardous waste, such as wastewater, Cl2, NOx and SO2, which may negatively impact the environment.

Another example of a hydrometallurgical technique is that of electrochemical separation, where differences in the standard reduction potential of metal ions are exploited to separate the metal ion of interest under the influence of an applied potential.

KR102383123 discloses a recycling technique for a waste battery, including a method for separating and recovering constituent materials, where the batteries are crushed, the components of the battery are grinded, thereby subjecting the materials to size reduction, before removal of the electrolyte using heat removal or decomposition. Subsequently, the positive electrode materials are separated by application of a magnetic force, and the anode materials by gravity separation. The metal components are separated by electrochemical processes. Grinding the materials is unfavourable as it can result in downstream contamination issues, and heat removal or decomposition is unfavourable because it can alter the state of the battery component materials, leaving residual elements or pollutants.

Another process that has been considered for battery recycling is froth flotation. Froth flotation processes have been known for many years as a way to recover graphite from ore. Graphite recovery using the froth flotation process was first patented by the Bessel brothers in 1887, outlining the beneficiation process from ores using 1 to 10% oil and more than 16 different sources of oil (Bessel Bros., 1877, “Verfahren zur reinigung von graphit” (“Method for the purification of graphite”). German Patent Office, K. P. I. P. (Ed.)).

More recently, froth flotation processes have been used to recover graphite from batteries. Froth flotation processes selectively separate hydrophobic materials e.g., graphite, from hydrophilic materials. Frothing agents are typically used to enhance the flotation of graphite, one such widely used frothing agent is methyl isobutyl carbinol (MIBC). The use of frothing agents achieves higher surface tension by lowering the bubble sizes in the froth. Generally, non-ionic hydrocarbons, for example kerosene, fuel oil, paraffin and diesel oil, are used as collectors which help the hydrophobic materials adhere to the bubbles in the froth. Depressants may also be used to help the hydrophilic materials sink or separate from the froth.

WO2011/143061 describes the separation of materials in battery and electrochemical cells by employing froth flotation techniques. Bulk materials, such as casings, are removed from converted battery scrap and the resultant pulp is subjected to froth flotation. Froth flotation agents, including frothers, collectors and/or depressants, are used to manipulate the hydrophilic and hydrophobic nature of the materials in the scrap. Hydrophobic materials are entrained in the air bubbles of the froth and float out of the froth flotation vessel while those that are hydrophilic remain in the vessel, thereby separating battery grid materials.

WO2013148809A1 discloses a process and system for the separation of materials from electrochemical cells. Electrode materials are removed from electrochemical cells and separated into constituent active materials using magnetic separation. However, magnetic separation is effected only after wet processing of the combined electrochemical cell materials and fails to recognise any benefit of separating anodic and cathodic materials in dry form prior to wet processing.

As a result, the amount of carbon (graphite) recovered using this and other prior art froth flotation processes is relatively low.

Thus, there remains a need in the art for a process for recovering critical materials from batteries, particularly lithium-ion batteries, which addresses the problems associated with the prior art processes and which has a reduced environmental impact.

### SUMMARY OF INVENTION

According to a first aspect of the invention there is provided a process for the recovery of a useful material from a battery, comprising the steps of:
a. treating at least part of a battery to form a feed stream comprising anode material, cathode material and an electrolyte;
b. removing the electrolyte from the feed stream to provide a processed battery feedstock;
c. separating the anode material and cathode material from the processed battery feedstock into distinct material streams by means of (electro)magnetic and/or electrostatic separation; and
d. treating the anode material stream to obtain a graphite product and/or treating the cathode material stream to obtain a cathode active material product.

In one embodiment of the present invention, in step d., treating the anode material stream obtains a separated copper foil product stream, in addition to the graphite product. In another embodiment, in step d. treating the cathode material stream obtains a separated aluminium foil product stream, in addition to the cathode active material product stream. Therefore, in a particular embodiment of the present invention, step d. comprises treating the anode material stream to obtain separated graphite and copper foil product streams and/or treating the cathode material stream to obtain separated aluminium foil and cathode active material product streams.

The inventors of the present invention have found that it is advantageous to separate the anode material from the cathode material prior to treatment of the material streams to obtain the critical material i.e., the graphite or cathode active material products. This separation step increases the recovery efficiency as appropriate, meaning that targeted treatment of the different material streams can be applied. For example, the anode material stream may be treated using a froth flotation process to obtain the graphite product. Additionally, or alternatively, the cathode material stream may be treated using a hydrometallurgy process to obtain the cathode active material product.

Hydrometallurgical processes may comprise either green solvent hydrometallurgy or acid hydrometallurgy. Green solvent hydrometallurgy is a separation process where green solvents, those which have reduced environmental impact, are used to dissolve the cathode binder. Acid hydrometallurgy, which is also known as hydrometallurgical recovery, is where an acid is used to facilitate recovery of the materials that make up the cathode active materials.

In the process of the invention, (electro)magnetic and/or electrostatic separation of anodic and cathodic materials is preferably conducted in dry form following removal of electrolyte from the treated (e.g., comminuted, shredded) scrap battery and/or end-of-life battery feedstock and before any further wet processing of the materials to dissolve the binders usually present in both anodic and cathodic materials. By separating the anodic and cathodic materials higher up in the process, just after shredding and electrolyte removal, the active materials can be more effectively recovered. Dry separation enables a greater number of processing routes, owing to the avoidance of incompatibility of wet separated materials.

Additionally, it is advantageous to separate the anode and cathode material higher up the process flow, before treatment of the material streams, as this effectively facilitates two separations in a single step, reducing the number of processing steps downstream, whilst also reducing contamination in the material streams. Reducing contamination, especially in the cathode active material stream makes downstream processing steps easier. For example, copper and aluminium contaminants are separated, but because the graphite and cathode active materials remain attached to the foil (typically as powders), separation of the graphite powder from the cathode active material powder is also possible.

Advantageously, the invention according to the first aspect solely includes shredding insofar as generation of the feed stream is concerned, and does not require any further size reduction steps, such as grinding to form powders. Grinding the materials is unfavourable as it results in downstream contamination issues, especially for aluminium and copper foils. This is primarily because size reduction steps can apply not only to the metal foils, but also the casing, the polymer, the binder, which will create a mixed mass of materials, requiring further complex separation downstream, or additional hydrometallurgical or pyrometallurgical steps. For example, depending on the method achieved to make the powders, copper and aluminium residues would be included in them, requiring extra processing to remove them.

Furthermore, the process of the invention avoids the need for heat decomposition steps to remove binder material typically present in the battery. Heat removal or decomposition is unfavourable because it can alter the state of the battery component materials and may leave residual elements or pollutants. For example, in conventional lithium-ion batteries the cathode binder may be polyvinylidene fluoride (PVDF), which if treated with heat produces carbon monoxide, carbon dioxide and hydrogen fluoride. These contaminants and pollutants would need to be addressed should this method be employed, hence the advantage of the invention in preventing contaminants of residual elements from this heat treatment, and any other associated pollutants.

The processed battery feedstock is preferably a dry processed battery feedstock.

Consequently, the invention also provides a processed battery feedstock for recovery of graphite and/or cathode active material comprising dried, comminuted, particulate residue comprising at least two fractions, a first fraction comprising graphite in association with a binder and foils (usually copper foils), and a second fraction comprising cathode active material in association with a binder and foils (usually aluminium foils).

The invention also concerns the use of such a first fraction in a process for obtaining graphite for recycling; and the use of such a second fraction in a process for obtaining cathode active material for recycling or reuse investigations.

The process of the present invention may be used to recover useful material from any suitable type of battery. However, it is particularly effective at recovering useful material from lithium-ion batteries.

In general, lithium-ion batteries include an anode, a cathode, and an electrolyte. The anode typically comprises graphite attached to a metal foil (e.g., a copper foil) with a binder. The binder may be a water-soluble binder such as carboxymethyl cellulose (CMC) or styrene-butadiene rubber (SBR). The cathode typically comprises cathode active materials, for example lithium, nickel, manganese and cobalt, attached to a metal foil (e.g., an aluminium foil) with a binder. A commonly used binder in the cathode is poly (vinylidene fluoride) (PVDF), although increasingly other binders are being utilised for the cathode binder to reduce the environmental impact of the materials used, such as for example polyacrylate latex (PAL).

As an intermediate step prior to step d., but after step c., the anode material stream may be treated to dissolve anode binder, thus releasing the graphite from the metal foil. The treatment may be carried out first in a bath to dissolve the binder(s). In some cases, the anode material stream may be further treated using a froth flotation process to obtain and purify the graphite product in step d, depending on the effectiveness of the water bath.

The inventors of the present invention have found that the intermediate step of dissolving anode binder(s), after separation of cathodic from anodic materials, to release the graphite from the metal foil has the benefit of improving the efficiency of the graphite recovery during froth flotation. Without wishing to be bound by any such theory, it is believed that by separating the hydrophobic graphite from the hydrophilic metal foil and any associated binder(s), more of the graphite adheres to the air bubbles in the froth flotation process and is subsequently recovered. This has not previously been recognised in the prior art.

The cathode material stream may be treated using a hydrometallurgy process to obtain the cathode active material product in step d. As an intermediate step prior to step d., but after step c., the cathode material stream may be treated to dissolve cathode binder(s), thus releasing the cathode active materials from the metal foil.

The inventors of the present invention have found that the intermediate step of dissolving the cathode binder(s), which holds the cathode active material together, after separation of cathodic from anodic materials, provides a cleaner cathode material stream for after step d. where the cathode active materials have been released from the metal foil, this results in an increase in yield efficiency in the subsequent treatment. Additionally, it has been found that the cathode binder can be successfully dissolved using “green” solvents, for example water, dimethyl sulfoxide, γ-valerolactone, dihydrolevoglucosenone or dimethyl isosorbide.

“Green” solvents are solvents that minimise the environmental impact resulting from the use of solvents in chemical processes. Using “green” solvents has the benefit of a reduced environmental impact versus traditional solvents, because green solvents are bio-renewable, meaning that they can be obtained from, or derived from, natural resources.

The “greenest” solvent is water, and thus, in some examples of the present invention the cathode binder may be successfully dissolved using water, for example in a water-bath, especially where the cathode binder is itself water-based, for example if the cathode binder comprises PAL.

As previously outlined, conventional hydrometallurgy processes involve the use of strong acids, with sulphuric acid being favoured in many of the prior art processes. However, the inventors of the present invention have surprisingly found that in addition to sulphuric acid, a weak acid, particularly a weak inorganic acid such as phosphoric acid, can be successfully used in the hydrometallurgy process to leach out the cathode active material product e.g., lithium, nickel, manganese and cobalt. Weak inorganic acids are much easier to handle than strong acids. In addition, the inventors have found that, although an inorganic acid is used, the waste materials are not environmentally damaging and are much easier to treat and/or regenerate into useful products.

Where phosphoric acid is used, additional advantages may be realised. In this scenario, the wastewater from the hydrometallurgy process will contain trisodium phosphate. By adding calcium hydroxide to the wastewater, sodium hydroxide can be produced along with a calcium phosphate by-product. The former can be reused in the hydrometallurgy process, and the latter can be repurposed for use in supplements or antacids, for example. A further advantage of using phosphoric acid is that lithium recovered as one of the cathode active material products will be in the form of lithium phosphate. This may be preferred in some circumstances by lithium refiners as lithium phosphate can sometimes be easier to process compared to lithium sulphate and lithium carbonate.

The initial treatment of the battery to form a feed stream comprising anode material, cathode material and an electrolyte may be effected by the steps of discharging, comminuting, and shredding the battery, or part of it.

### BRIEF DESCRIPTION OF DRAWINGS

FIG. 1 is a schematic flowsheet representing a process in accordance with the invention.

FIG. 2 is an XRD and XRF analysis of the Ni-DMG complex precipitate.

### DETAILED DESCRIPTION

The inventive process relates to the recovery of a useful material from a battery. The battery may be any suitable type of battery, such as lithium-ion or EV. However, the process is particularly effective at recovering useful material from lithium-ion batteries, for example EOL lithium-ion batteries and scrap from gigafactories.

Lithium-ion batteries comprise an anode, a cathode and an electrolyte.

The anode comprises graphite. The graphite may be attached to a metal foil, for example a copper foil, using a binder. The anode binder may comprise a water-soluble binder such as carboxymethyl cellulose (CMC) or styrene-butadiene rubber (SBR), or other conventional binder materials.

The cathode comprises cathode active materials, for example lithium, nickel, manganese and cobalt. The cathode active materials may be attached to a metal foil, for example an aluminium foil, with a binder. The cathode binder may comprise poly(vinylidene fluoride) (PVDF), or other conventional binder materials, which may include, but not limited to, water-based binder materials.

Conventional binder materials may be hydrophilic or hydrophobic.

The lithium-ion batteries may additionally comprise other conventional components, for example a separator, and a casing.

The battery is discharged, comminuted, and shredded to form a feed stream, using conventional methods such as those described in Velázquez-Martínez, O.; Valio, J.; Santasalo-Aarnio, A.; Reuter, M.; Serna-Guerrero, R., A Critical Review of Lithium-Ion Battery Recycling Processes from a Circular Economy Perspective, Batteries, 2019, 5, 68.

In the preferred process according to the invention, the shredded materials are not subjected to any further grinding or size reduction. In conventional processes, size reduction is a standard technique used for materials processing and, depending on the materials involved, can be both time consuming and wear out the machinery quickly.

In the present invention, the battery is simply shredded, the electrolyte removed and then the anode and cathode materials separated. The anode and cathode materials are separated by electromagnetic separation and treated discretely from one another. The anode materials are transferred to a water bath to dissolve binder(s), and the cathode materials are transferred to a green solvent bath to dissolve binder(s). In an exemplary embodiment where the cathode binder comprises water based binders such as PAL, a water bath may be used as the green solvent bath to dissolve the cathode binder. Therefore, the process separates the foils from the powders, copper from aluminium, and CAM powders from graphite powders.

By refraining from grinding the processed battery feedstock, the separation process is advantageously cleaner than conventional processes in the art. The processed battery feedstock of the invention and in the process thereof preferably comprises foil flakes (for example, foil flakes formed from shredding of the battery) of approximately ≥1.5 mm, preferably approximately ≥2 mm in size in any dimension. These flakes may be washed to efficiently remove powders of <50 μm in size. Additionally, by treating the anode and cathode separately, the graphite is separated from the cathode active materials, and the aluminium foils is separated from the copper.

The electrolyte is removed from the feed stream. Removal of the electrolyte may be carried out using standard techniques, for example vacuum drying or a solvent wash, as described in Brückner, L.; Frank, J.; Elwert, T., Industrial Recycling of Lithium-Ion Batteries—A Critical Review of Metallurgical Process Routes, Metals, 2020, 10, 1107.

In the process according to the present invention, removal of the electrolyte by solvent wash is preferred. Removal by solvent wash is mild, and avoids the disadvantages associated with heat removal or decomposition, which can result in the decomposition or alteration of the component materials, and/or introduction of contaminants.

The processed battery feedstock following electrolyte removal comprises anode material and cathode material, typically in association with one or more binders. The processed battery feedstock may also comprise the plastic separator of the battery. These material streams are preferably provided in dry form following such processing, before subsequent (electro)magnetic processing.

The anode material and cathode material are separated from the feed stream into distinct material streams using (electro)magnetic separation. One suitable method utilises a rare earth permanent magnetic roll separator, where the dry feedstock is evenly fed on to a conveyor belt, a high intensity rare earth magnet (e.g. Neodymium Iron Boron permanent magnet) built into the roll pulls the conveyor (and materials) forward, as the materials go over the roll, and depending on the magnetic make-up of the materials, they will interact with the rare earth magnet differently, giving them a different trajectory allowing separation of materials by their material properties. Before feeding into the rare earth permanent magnetic roll machine, it is important that all ferrous materials are removed. Suitable machinery is supplied by Bunting-Redditch, Burnt Meadow Road, North Moons Moat, Redditch, Worcestershire, United Kingdom, B98 9PA; https://www.bunting-redditch.com/product/rare-earth-roll/.

It is an advantage of the invention that by completing the magnetic separation higher up in the process, two major separated streams are provided; the anode stream, which may typically comprise copper foil, with graphite adhered to it with binder, and the cathode stream which may typically comprise aluminium foil with cathode active material adhered to it with binder. Additionally, the polymer, which may consist of the plastic separator in the battery, may be separated from the rest of the materials and the fines<2 mm.

Alternatively, electrostatic separators are known to separate aluminium and graphite (https://www.bunting-redditch.com/product/electrostatic-separator/). An alternative suitable method therefore includes electrostatic separation, where the feedstock is evenly fed onto the revolving stainless-steel earthed roll (typically 20-50 rpm) and subjected to a high-tension discharge from a fine tungsten wire electrode (ionising electrode). Poor conductors (insulators) remain charged, are pinned by an image force on the roll surface, and then, are discharged by the brush. Conductors quickly lose their charge and are thrown off the roll on their natural trajectory.

In the process according to the invention, (electro)magnetic and/or electrostatic separation of anodic and cathodic materials may be conducted on the processed battery feedstock, in a dry form following removal of electrolyte from the treated (e.g., comminuted, shredded) battery prior to any further wet processing of the materials. Advantageously, dry separation enables the separation of non-ferrous materials from one another based on the material properties and how the electrode materials respond to a magnetic electrostatic force, which permits the separation of a broader array of materials than conventional methods, not just being limited to mixtures of ferrous and non-ferrous materials.

In standard techniques where separation is not used prior to the treatment steps, contaminants may affect the quality of the end product. Particularly, froth flotation of the anode materials, such as graphite, and the cathode active material powders may be hindered by relying solely on size reduction steps, without separation of the anode and cathode materials. Particularly, if the anode binder is not removed from the graphite prior to the treatment steps it may reduce the efficiency or even prevent successful froth flotation. Whilst graphite is hydrophobic and is suitable for froth flotation, typical anode binders, such as styrene-butadiene rubber (SBR) or carboxymethyl cellulose (CMC), are hydrophilic, which would affect the froth flotation process. For example, should cathode materials reach the froth flotation tank, the cathode binder, typically PVDF, which is hydrophobic could also impact the separation efficiency of the technique by contaminating the graphite and resulting in a yield loss to the recovery of the cathode material.

The feed stream following electrolyte removal comprises anode material and cathode material, typically in association with one or more binders. An electrode-active material is held together by a binder, a compound that is electrochemically inert but has the strength to afford mechanical support. The cathode and anode typically have different binders, requiring different tailored treatments. Therefore, separating the cathode and anode materials early in the process, as in the present invention, improves downstream removal of binder and treatment of the active materials.

As an intermediate step prior to step d., the anode material stream may be treated to dissolve the anode binder. This has the advantage of releasing the graphite from the foil. The intermediate step may involve subjecting the anode material stream to a hot water bath. The anode binder is typically water-based, allowing the graphite to be separated from the copper in a water bath (solvent free) at moderate temperature, with the CAM and aluminium contamination already removed. Once the copper is clean the graphite powders may be removed and separated giving two materials streams. Froth flotation may not be required.

The hot water bath may be maintained at a temperature of from about 50° C. to about 120° C., for example from about 60° C. to about 100° C. The anode material stream may be immersed in the hot water bath for any suitable period of time to dissolve the binder, for example from about 1 to about 10 hours.

One or more hot water bath treatments may be used. It may be preferable to subject the anode material stream to multiple hot water baths to dissolve a greater proportion of the anode binder.

The anode material stream may be treated using a froth flotation process to obtain the graphite product in step d.

Similarly, as another intermediate step prior to step d., the cathode material stream may be treated to dissolve the cathode binder, thus releasing the cathode active materials from the metal foil. The cathode material may comprise cathode active materials, for example lithium, nickel, manganese and cobalt, attached to a metal foil (e.g., an aluminium foil) with a binder.

The binder may comprise poly(vinylidene fluoride) (PVDF), or other conventional binder materials, which may include, but not limited to, water-based binder materials, such as for example polyacrylate latex (PAL). The conventional binder materials may be hydrophilic or hydrophobic.

The cathode binder may be dissolved using “green” solvents.

“Green” solvents are solvents that minimise the environmental impact resulting from the use of solvents in chemical processes. Green solvents are those which are better for worker health, are non-toxic or have low toxicity; those which are more sustainable, have a lower environmental impact, or have a reduced/don't contribute to greenhouse gas emissions; or simply those which are energy efficient. Importantly, green solvents are able to minimise environmental impact, whilst still maintaining efficiency in operation.

Due to difference in density between water and green solvents, the latter may be effectively recycled. Advantageously, green solvents are safe to handle, environmentally friendly and highly stable towards oxidation.

In particular, embodiments of the invention, the green solvents may include water, dimethyl sulfoxide, γ-valerolactone, dihydrolevoglucosenone or dimethyl isosorbide. Cyrene (dihydrolevoglucosenone) and γ-valerolactone are particularly preferable examples, as both these green solvents are derived from natural resources. For example, γ-valerolactone is derived from cellulose via the production of hydroxymethylfurfural to levulinic acid, or via furfural from hemicellulose, and Cyrene is produced by converting cellulose into levoglucosenone, which is subsequently hydrogenated to Cyrene.

In a more specific embodiment of the invention, where the green solvent is water, a water-bath may be used for the dissolution of the cathode binder. This embodiment may be of particular importance, where the cathode binder may be water-based, for example if the cathode binder is PAL.

The cathode binder is typically PVDF, and using a green solvent to dissolve the binder allows the cathode active material powders to be efficiently separated, producing clean aluminium foils. The production of clean aluminium, and copper, foils is advantageous as they can go directly to recycling with no or minimal contamination, increasing their value.

In processes according to the invention, where the anode material and the cathode active material have been separated before binder removal with minimal contamination, either or both product powders may be used in further processes. For example, cathode active material powders will have minimal contamination for further processing steps, such as in a typical NMC battery, the cathode powders typically will contain four elements; nickel, manganese, cobalt and lithium, which simplifies the hydrometallurgical or pyrometallurgical recovery steps.

The material stream is treated using a hydrometallurgy process to obtain the cathode active material product in step d. The hydrometallurgy process may comprise leaching the cathode material stream with a weak acid, such as for example phosphoric acid, to obtain a leachate.

Alternatively, a stronger acid, such as sulphuric acid, may be used in the hydrometallurgy process of step d. Advantageously, higher value end products may be obtained if sulphuric acid is used for leaching.

In an exemplary embodiment, the cathode active material may be treated with sodium hydroxide solution to remove the shredded aluminium foils present in the mixture, and subsequently the cathode active material may be dissolved in sulphuric acid, optionally with hydrogen peroxide, which helps in changing the oxidation states of Co, Mn and Ni. This may be carried out at an elevated temperature, such as for example 70° C. for 3 hours. The resultant leachate may be filtered out and taken for further processing.

In hydrometallurgical processes according to the invention, a leachate may be collected. Valuable metals may be recovered from the leachate by precipitation. For example, a multi-step directional precipitation method may be used to recover valuable metals from the leachate. Different chemicals may be used to selectively precipitate the constituent metals.

In some embodiments, oxalic acid may be used to precipitate nickel and cobalt by adjusting the pH of the solution. In other embodiments, ammonium persulphate ((NH4)2S2O8) solution may be added to the leachate to precipitate out manganese from the leachate.

The addition of oxalic acid, which can be found naturally occurring in the environment, into the leachate enables the precipitation of majority of nickel and cobalt, some manganese and precipitates any traces of copper. Sodium hydroxide may be used to adjust the leachate pH level, enabling the remaining manganese to precipitate, with traces of nickel and cobalt, and any traces of aluminium. Lithium phosphate is produced during this step.

The invention is more particularly described with reference to the Figures and Examples wherein:

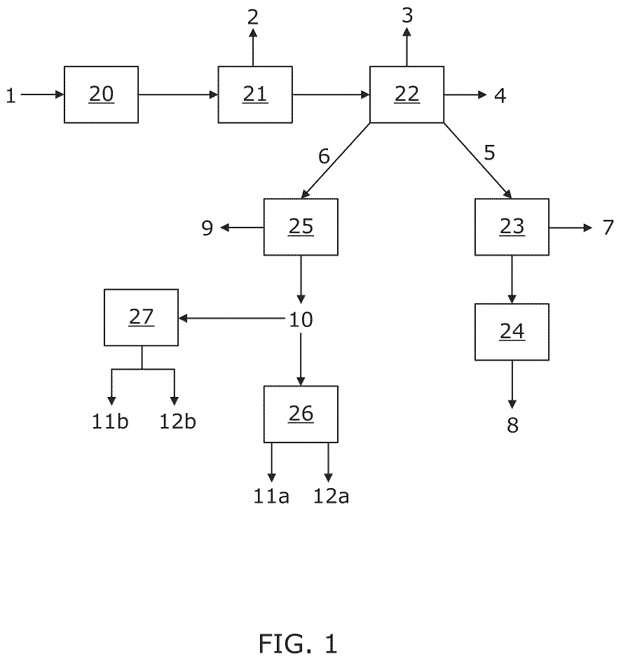

FIG. 1 is a schematic flowsheet representing a process in accordance with the invention.

Referring to FIG. 1, there is shown schematically a process in which scrap cell feedstock (1) in the form of end-of-life lithium-ion batteries is discharged, disassembled and shredded under inert gas conditions in accordance with conventional procedure in an inert gas shredder (20) (alternative shredding is possible, for example vacuum shredder or caustic/wet shredding). Electrolyte (2) is removed (21) by means of vacuum drying or solvent washing, which again is conventional in the art. The dry materials (typically comminuted foils and associated binders) arising from the electrolyte removal step are supplied to the feed drum or hopper of an (electro)magnetic separator (22), and four distinct fractions comprising fines (3), plastic (4), anodic material (5) and cathodic material (6) are separated and recovered.

The anode material stream (5) and the cathode material stream (6) are then treated separately.

The anode material stream (5) is subjected to binder dissolution (23) conditions in the presence of a suitable solvent (typically water) for the anode binder, and copper (7) is recovered by any suitable technique such as wash-off or gravity separation. The filtered recovered graphite is then subjected to froth flotation (24) (a known technique) to recover high purity graphite (8) for onward use in any suitable industry, for example for re-use in lithium-ion batteries, for use in the manufacture of graphene, or for use in refractory applications.

The cathode material stream (6) is subjected to binder dissolution (25) conditions in the presence of a suitable solvent (typically DMSO or other green solvent as aforesaid) for the cathode binder, and aluminium (9) is recovered by any suitable technique such as wash-off. The filtered recovered cathode active material (10) may then be subjected either to a pyrometallurgical process (26) or (preferably) a hydrometallurgical process (27) to separate Li (11a, 11b) from other metals (12a, 12b) such as Ni, Mn, Co in the cathode active material.

Pyrometallurgical processes (26) are capable of yielding the Li ore spodumene (11a), which is useful, but hydrometallurgical (27) processes may yield Li in even more useful form—such as lithium phosphate (11b) when phosphoric acid is used as a hydrometallurgical reagent.

Hence, in the hydrometallurgical route (27), a weak inorganic acid, such as phosphoric acid (e.g. 0.8 mol/l) may be used. This leaches out the CAM materials (11b, 12b) (nickel, manganese, cobalt and lithium); if any traces of copper or aluminium are present these will also be leached into solution.

The addition of oxalic acid (can be found naturally occurring in the environment) into the leachate enables the precipitation of majority of the additional metals (12b), such as nickel and cobalt, some manganese and precipitates any traces of copper. Sodium hydroxide may be used to adjust the leachate pH level, enabling the remaining additional metals (12b), such as manganese to precipitate, with traces of nickel and cobalt, and any traces of aluminium. Lithium phosphate (11b) is produced during this step.

In the ‘waste’ water, trisodium phosphate will be recovered. By adding calcium hydroxide, sodium hydroxide is produced which can be used again, leaving calcium phosphate as a by-product (used in supplements and antacids). This route may use an inorganic acid, but the ‘wastes’ are not environmentally damaging, lithium is recovered as lithium phosphate-possible inputs for lithium refiners, lithium-iron phosphate batteries (LFP).

Hydrometallurgy (27) is the most favoured route for the extraction of constituent elements from the lithium-ion battery (1). Although sulphuric acid has often been the conventional preferred choice of solvent, we find that a weak acid such as phosphoric acid is preferred because such solvents are easier to handle industrially, and the generated wastes are more straightforwardly treated/regenerated to form useful products. Lithium phosphate (11b) is preferred by lithium refiners as it is easier to process compared to lithium sulphate and lithium carbonate. In the process of the invention the preliminary separation of graphite (8) before binder dissolution (25) facilitates selection of the hydrometallurgical route.

### EXAMPLES

### Example 1

A scrap cell feedstock was subjected to the initial pre-treatment stages of discharge, disassembly, inert gas shredding and electrolyte removal which are conventional in the art. The dried feedstock was subjected to (electro)magnetic separation using a Bunting-Redditch Rare Earth Roll Separator operating in accordance with manufacturer's specifications to obtain four separate dry fractions comprising anode material, cathode material, plastic and fines.

Once separated the anode and cathode materials were separately treated and the following experiments exemplify the nature of such treatment.

### Anode Treatment

The anode material was found to comprise graphite anode and a water-soluble binder cast onto a copper foil. The anode was shredded into small pieces, typically of the order of 10-20 mm² and placed with water in an ultrasonic bath at 70° C. for 1.5 hours for removal of the water-soluble binder.

Copper foil was separated out and Scanning Electron Microscopy was carried out on the recovered graphite. Two specific locations on the recovered graphite were identified, Site 1 and Site 2, and EDX elemental analysis carried out on samples from these locations showed the following results:

| Elemental Composition | | |
|---|---|---|
| (wt. %) | Site 1 | Site 2 |
| C | 87.96 | 87.36 |
| O | 7.88 | 6.30 |
| F | 1.98 | 2.84 |
| Mg | 0.14 | |
| Al | | |
| P | 0.32 | |
| Cl | | |
| Ca | | 0.83 |
| Cu | | 2.67 |
| Total | 100 | 100 |

The recovered graphite was then subjected to a froth flotation process as described in WO2011143061A1 following which high purity graphite is obtained.

### Cathode Treatment

The cathode material was found to comprise LiMnNiCo cathode and a PVDF binder cast onto an aluminium foil. The cathode was shredded into small pieces of the order of 10-20 mm² and placed with DMSO in an ultrasonic bath at 58° C. for 15 minutes for removal of the binder. Aluminium was removed by wash-off. Scanning Electron Microscopy of two locations on the recovered cathode material showed Mn:Ni:Co ratio of 1:1:1 both before and after processing, indicating successful recovery of the cathode active materials from the associated foil/binder.

The recovered cathode active material was then subjected to treatment with phosphoric acid to obtain high purity lithium phosphate.

### Example 2

A multi-step directional precipitation method was used to recover valuable metals from a leachate obtained from a hydrometallurgical process.

CAM was dissolved in sulphuric acid along with hydrogen peroxide at 70° C. on a hotplate and dissolved for 3 hours. The leachate was filtered out and taken for further processing, which had a pH of this leachate of about 0.6. Ammonium persulphate ((NH₄)₂S₂O₈) solution was added to the leachate to precipitate out manganese from the leachate. A Mn rich phase is precipitated out at 60° C. after mixing for 2 hours. A co-existence of Cobalt phase was observed in the system.

Scanning Electron Microscopy was carried out on the recovered Mn-rich precipitate and three specific locations were identified, Site 3, Site 4 and Site 5. EDX elemental analysis was carried out on samples from these locations of the Mn-rich precipitate, the results of which are given in the table below:

| Elemental | | | |
|---|---|---|---|
| Composition | | | |
| (wt. %) | Site 3 | Site 4 | Site 5 |
| C | 1.54 | 5.60 | 5.01 |
| O | 7.91 | 32.14 | 29.63 |
| Na | 0.14 | 1.69 | 1.34 |
| Si | | 0.21 | 0.63 |
| P | 0.07 | 0.07 | 0.11 |
| S | | 0.05 | |
| Ca | 0.85 | 0.66 | 0.79 |
| Mn | 84.25 | 51.22 | 53.15 |
| Fe | | 4.16 | 3.91 |
| Co | 4.49 | 4.20 | 4.62 |
| Ni | 0.73 | | 0.80 |
| Total | 100.00 | 100.00 | 100.00 |

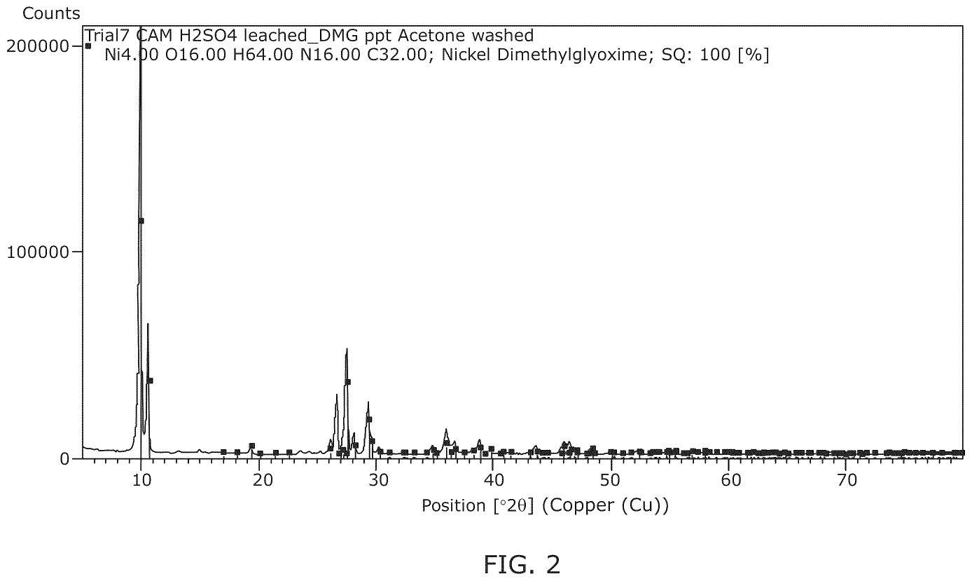

The remaining CAM leachate was mixed with Dimethylglyoxime, DMG (C₄H₈N₂O₂) at room temperature for 2 hours. At a pH of 3.5 after the addition of NaOH, a precipitate of Ni-Dimethylglyoxime complex was observed. A single-phase Ni-DMG complex was obtained after washing with acetone. XRD and XRF analysis of the Ni-DMG complex precipitate is given in FIG. 2 and the table provided below:

| | Mass (%) | | | | | | | |
|---|---|---|---|---|---|---|---|---|
| Components | Al₂O₃ | SiO₂ | SO₃ | MnO | Fe₂O₃ | Co₂O₃ | NiO | CuO |
| CAM_DMG | 0.0773 | 0.0499 | 0.4068 | 0.0346 | 0.0481 | 2.2173 | 96.2740 | 0.8920 |

By adjusting the pH of the remaining leachate, cobalt ions were separated from lithium ions. It was found that the precipitation rate of cobalt ions increased with increases of pH until about pH 10. Further increases in pH had no significant influence.

Finally, the remaining leachate was mixed with sodium carbonate at about 90° C., and the lithium ions were recovered as lithium carbonate.

1. A process for the recovery of a useful material from a battery, comprising the steps of:
(a) treating at least part of a battery to form a feed stream comprising anode material, cathode material and an electrolyte;
(b) removing the electrolyte from the feed stream to provide a processed battery feedstock;
(c) separating the anode material and cathode material from the processed battery feedstock into distinct anode material and cathode material streams by means of (electro)magnetic and/or electrostatic separation; and
(d) treating the anode material stream to obtain a graphite product and/or treating the cathode material stream to obtain a cathode active material product.

2. The process of claim 1, wherein the separation step (c) is effected by means of dry (electro)magnetic separation.

3. The process of claim 1, wherein the anode material stream is treated in step (d) using a froth flotation process to obtain the graphite product.

4. The process of claim 3, wherein the anode material comprises graphite attached to a metal foil with a binder.

5. The process of claim 4, wherein the binder is a water-soluble binder.

6. The process of claim 4, wherein as an intermediate step prior to step (d), but after step (c), the anode material stream is treated to dissolve the anode binder, thus releasing the graphite from the metal foil.

7. The process of claim 6, wherein the intermediate step of dissolving the anode binder to release the graphite from the metal foil is effective to improve the efficiency of the graphite recovery during froth flotation.

8. The process of claim 7, wherein the step of separating the hydrophobic graphite from the hydrophilic metal foil and hydrophilic binders prior to froth flotation is effective to increase the quantity of graphite adhering to air bubbles in the froth flotation process.

9. The process of claim 1, wherein the cathode material comprises cathode active materials attached to a metal foil with a binder.

10. The process of claim 9, wherein the binder comprises poly(vinylidene fluoride) (PVDF) or other conventional binder materials.

11. The process of claim 9, wherein as an intermediate step prior to step (d), but after step (c), the cathode material stream is treated to dissolve the cathode binder, thus releasing the cathode active materials from the metal foil.

12. The process of claim 11, wherein the cathode binder is dissolved using “green” solvents.

13. The process of claim 1, wherein the cathode material stream is treated using a hydrometallurgy process to obtain the cathode active material product.

14. The process of claim 13, wherein the hydrometallurgy process comprises leaching the cathode material stream with a weak acid.

15. The process of claim 14, wherein the weak acid comprises phosphoric acid.

16. The process of claim 15, wherein wastewater from the hydrometallurgy process contains trisodium phosphate.

17. The process of claim 16, comprising adding calcium hydroxide to the wastewater, to yield sodium hydroxide and calcium phosphate by-products, and lithium phosphate as a useful material.

18. The process of claim 1, wherein step (a) is effected by the steps of comminuting, discharging and shredding the battery, or part of it.

19. The process of claim 1, wherein the battery is a lithium-ion battery.

20. A processed feedstock for recovery of graphite and/or cathode active material comprising dried, comminuted, particulate residue comprising at least two fractions, a first fraction comprising graphite in association with a binder, and a second fraction comprising cathode active material in association with a binder.

21. A method for obtaining graphite for recycling from the first fraction of claim 20, comprising the step of separating the binder from the graphite.

22. A method for obtaining cathode active material for recycling from the second fraction of claim 20, comprising the step of separating the binder from the cathode active material.
